(19) United States
(12) Patent Application Publication
(10) Pub. No.: US 2007/0129944 A1
(43) Pub. Date: Jun. 7, 2007

(54) METHOD AND APPARATUS FOR COMPRESSING A SPEAKER TEMPLATE, METHOD AND APPARATUS FOR MERGING A PLURALITY OF SPEAKER TEMPLATES, AND SPEAKER AUTHENTICATION

(75) Inventors: Jian Luan, Beijing (CN); Jie Hao, Beijing (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/550,533

(22) Filed: Oct. 18, 2006

(30) Foreign Application Priority Data
Nov. 11, 2005 (CN) 200510115300.5

(51) Int. Cl. G10L 17/00

(52) U.S. Cl. 704/246

(57) ABSTRACT

The present invention provides a method and apparatus for compressing a speaker template, a method and apparatus for merging a plurality of speaker templates, a method and apparatus for enrollment and verification of speaker authentication, a system for speaker authentication. Said method for compressing a speaker template that includes a plurality of feature vectors, comprising: designating a code to each of said plurality of feature vectors in said speaker template according to a codebook that includes a plurality of codes and their corresponding feature codes; and replacing a plurality of adjacent feature vectors designated with the same code in the speaker template with a feature vector.

### TECHNICAL FIELD

The present invention relates to information processing technology, specifically to the technology of compressing a speaker template, merging a plurality of speaker templates and speaker authentication.

### TECHNICAL BACKGROUND

By using the pronunciation features of each speaker when he/she is speaking, different speakers may be identified, so that speaker authentication can be performed. In the article “Speaker recognition using hidden Markov models, dynamic time warping and vector quantisation” by K. Yu, J. Mason, J. Oglesby (Vision, Image and Signal Processing, IEE Proceedings, Vol. 142, October 1995, pp. 313-18), three common kinds of speaker identification engine technology are introduced, which are HMM, DTW and VQ.

Usually, the process of speaker authentication includes two phases, enrollment and verification. In the phase of enrollment, the speaker template of a speaker is generated based on an utterance containing a password spoken by the same speaker (user); in the phase of verification, it is determined whether the test utterance is the utterance with the same password spoken by the same speaker based on the speaker template. Therefore, the quality of a speaker template is very important to the whole process of authentication.

It is known that, in order to enhance the quality of a speaker template, a plurality of training utterances may be used to construct a speaker template. First, one training utterance is selected as an initial template, to which a second utterance is then time aligned by using the DTW method. The averages of the corresponding feature vectors in these two utterance segments are used to generate a new template, to which a third utterance is then time aligned and so on. This process is repeated until all the training utterances have been combined into a separate template. This process is called template merging. For a detailed description, reference may be made to the article “Cross-words reference template for DTW-based speech recognition systems” by W. H. Abdulla,D. Chow and G. Sin (IEEE TENCON 2003, pp. 1576-1579).

On the other hand, if template compression is needed to save storage space, a simple down sampling is usually conducted on the series of feature vectors in the template. For a detailed description, reference may be made to the article “Enhancing the stability of speaker verification with compressed templates” by X. Wen and R. Liu (ISCSLP 2002, pp. 111-114). However, compressing a template with this method may affect the quality of the template and finally lead to the increase of authentication errors.

Furthermore, all the templates usually share an a priori threshold when only a few training utterances are available. As a result, due to the lack of focus of the threshold, the problem of rising error rate of authentication would occur too.

### SUMMARY OF THE INVENTION

In order to solve the above-mentioned problems in the prior technology, the present invention provides a method and apparatus for compressing a speaker template, a method and apparatus for merging a plurality of speaker templates, a method and apparatus for enrollment of speaker authentication, a method and apparatus for verification of speaker authentication and a system for speaker authentication.

According to an aspect of the present invention, there is provided a method for compressing a speaker template that includes a plurality of feature vectors, including: designating a code to each of the plurality of feature vectors in the speaker template according to a codebook that includes a plurality of codes and their corresponding feature vectors; and replacing a plurality of adjacent feature vectors designated with the same code in the speaker template with one feature vector.

Further, the sequence of codes corresponding to the feature vectors in the compressed speaker template may be saved as a background template

According to another aspect of the present invention, there is provided a method for merging a plurality of speaker templates, including: compressing the plurality of speaker templates respectively using the method for compressing a speaker template mentioned above; and DTW-merging the plurality of compressed speaker templates.

According to another aspect of the present invention, there is provided a method for merging a plurality of speaker templates, including: DTW-merging the plurality of speaker templates to form a separate template; and compressing the merged speaker template using the method for compressing a speaker template mentioned above.

According to another aspect of the present invention, there is provided a method for merging a plurality of speaker templates, including: compressing at least one of the plurality of speaker templates using the method for compressing a speaker template mentioned above; and DTW-merging the at least one compressed speaker template with the remaining ones of the plurality of speaker templates.

According to another aspect of the present invention, there is provided a method for enrollment of speaker authentication, including: generating a plurality of speaker templates based on a plurality of utterances inputted by a speaker; and merging the plurality of generated speaker templates using the method for merging a plurality of speaker templates mentioned above.

According to another aspect of the present invention, there is provided a method for verification of speaker authentication, including: inputting an utterance; and determining whether the inputted utterance is an enrolled password utterance spoken by the same speaker according to a speaker template that is generated by using the method for compressing a speaker template mentioned above.

According to another aspect of the present invention, there is provided a method for verification of speaker authentication, including: inputting an utterance; and determining whether the inputted utterance is an enrolled password utterance spoken by the same speaker according to a speaker template and a background template that are generated by using the method for compressing a speaker template mentioned above.

According to another aspect of the present invention, there is provided an apparatus for compressing a speaker template that includes a plurality of feature vectors, including: a code designating unit configured to designate a code to each of said plurality of feature vectors in the speaker template according to a codebook that includes a plurality of codes and their corresponding feature vectors; and a vector merging unit configured to replace a plurality of adjacent feature vectors designated with the same code in the speaker template with one feature vector.

According to another aspect of the present invention, there is provided an apparatus for merging a plurality of speaker templates, including: the apparatus for compressing a speaker template mentioned above; and a DTW merging unit configured to DTW-merge speaker templates.

According to another aspect of the present invention, there is provided an apparatus for enrollment of speaker authentication, including: a template generator configured to generate a speaker template based on utterances inputted by a speaker; and the apparatus for merging a plurality of speaker templates mentioned above, configured to merge a plurality of speaker templates generated by the template generator.

According to another aspect of the present invention, there is provided an apparatus for verification of speaker authentication, including: an utterance input unit configured to input an utterance; an acoustic feature extractor configured to extract acoustic features from the inputted utterance; a matching score calculator configured to calculate the DTW matching score of the extracted acoustic features and the corresponding speaker template, wherein the speaker template is generated by using the method for compressing a speaker template mentioned above; wherein it is determined whether the inputted utterance is an enrolled password utterance spoken by the same speaker through comparing the calculated DTW matching score with a predetermined decision threshold.

According to another aspect of the present invention, there is provided an apparatus for verification of speaker authentication, including: an utterance input unit configured to input an utterance; an acoustic feature extractor configured to extract acoustic features from the inputted utterance; a matching score calculator configured to calculate the DTW matching score of the extracted acoustic features and a speaker template and to calculate the DTW matching score of the extracted acoustic features and a background template, wherein the speaker template and the background template are generated by using the method for compressing a speaker template mentioned above; and a normalizing unit configured to normalize the DTW matching score of the extracted acoustic features and the speaker template with the DTW matching score of the extracted acoustic features and the background template; wherein the normalized DTW matching score is compared with a threshold to determine whether the inputted utterance is an enrolled password utterance spoken by the same speaker.

According to another aspect of the present invention, there is provided an apparatus for verification of speaker authentication, including: an utterance input unit configured to input an utterance; an acoustic feature extractor configured to extract acoustic features from the inputted utterance; a matching score calculator configured to calculate the DTW matching score of the extracted acoustic features and a speaker template and to calculate the DTW matching score of the speaker template and a background template, wherein the speaker template and the background template are generated by using the method for compressing a speaker template mentioned above; and a normalizing unit configured to normalize the DTW matching score of the extracted acoustic features and the speaker template with the DTW matching score of the speaker template and the background template; wherein the normalized DTW matching score is compared with a threshold to determine whether the inputted utterance is an enrolled password utterance spoken by the same speaker.

According to another aspect of the present invention, there is provided a system for speaker authentication, including: the apparatus for enrollment of speaker authentication mentioned above; and the apparatus for verification of speaker authentication mentioned above.

### BRIEF DESCRIPTION OF THE DRAWINGS

It is believed that through the following detailed description of embodiments of the present invention, taken in conjunction with the drawings, the above-mentioned features, advantages and objectives thereof will be better understood.

FIG. 1 is a flowchart showing a method for compressing a speaker template according to an embodiment of the present invention;

FIG. 2 is a flowchart showing a method for compressing a speaker template according to another embodiment of the present invention;

FIGS. 3A-3C are flowcharts showing methods for merging a plurality of speaker templates according to three embodiments of the present invention;

FIG. 4 is a flowchart showing a method for verification of speaker authentication according to an embodiment of the present invention;

FIG. 5 is a flowchart showing a method for verification of speaker authentication according to another embodiment of the present invention;

FIG. 6 is a flowchart showing a method for verification of speaker authentication according to still another embodiment of the present invention;

FIG. 7 is a block diagram showing an apparatus for compressing a speaker template according to an embodiment of the present invention;

FIG. 8 is block diagram showing an apparatus for merging a plurality of speaker templates according to an embodiment of the present invention;

FIG. 9 is a block diagram showing an apparatus for enrollment of speaker authentication according to an embodiment of the present invention;

FIG. 10 is a block diagram showing an apparatus for verification of speaker authentication according to an embodiment of the present invention;

FIG. 11 is a block diagram showing an apparatus for verification of speaker authentication according to another embodiment of the present invention; and

FIG. 12 is a block diagram showing a system for speaker authentication according to an embodiment of the present invention.

### DETAILED DESCRIPTION OF THE INVENTION

Next, a detailed description of preferred embodiments of the present invention will be given with reference to the drawings.

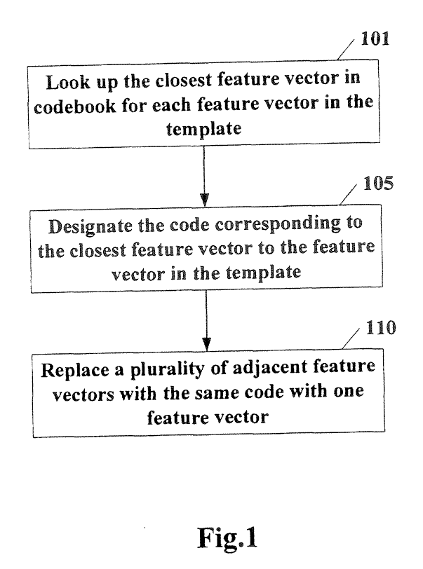

FIG. 1 is a flowchart showing a method for compressing a speaker template according to an embodiment of the present invention. As shown in FIG. 1, first in Step 101, for each feature vector in a speaker template that needs to be compressed, its closest feature vector is looked up in a codebook. The codebook used in this embodiment is a codebook trained in the global acoustic space of the application, for instance, for a Chinese language application environment, the codebook needs to be able to cover the acoustic space of Chinese utterances; while for an English language application environment, the codebook needs to be able to cover the acoustic space of English utterances. Of course, for some application environments with special purposes, the acoustic space covered by a codebook may be changed correspondingly

The codebook of this embodiment contains a plurality of codes and the feature vectors corresponding to the code respectively. The number of codes depends on the size of the acoustic space, desired compression ratio and desired compression quality. The larger the acoustic space is, the larger the number of the required codes is. With the same acoustic space, the smaller the number of the codes is, the higher the compression ratio is; and the larger the number of the codes is, the higher the compression quality is. According to a preferred embodiment of the invention, in an acoustic space of ordinary Chinese utterances, the number of the codes is preferably in the range of 256 to 512. Of course, the number of codes and covered acoustic space may be properly adjusted according to different requirements.

In this step, the closest feature vector may be found through calculating the distance (for instance, the Euclidean distance) between a feature vector in the speaker template and each feature vector in the codebook.

Next, in Step 105, the code corresponding to the closest feature vector in the codebook is designated to the corresponding feature vector in the speaker template.

Then, a single feature vector is used to replace a plurality of adjacent feature vectors with the same designated code in the speaker template. Specifically, according to this embodiment, first the average vector of the group of the adjacent feature vectors with the same code is calculated, and then the calculated average vector is used to replace the group of adjacent feature vectors with the same code.

If in the speaker template there are multiple groups each of which includes such adjacent feature vectors with the same code, these groups may be replaced one by one in the above-mentioned way. In this way, each group of feature vectors is replaced by one feature vector respectively, so that the number of feature vectors in the speaker template is reduced and the template is compressed.

From the above description it can be seen that if the method for compressing a speaker template of this embodiment is adopted, a speaker template can be compressed and in the case of this preferred embodiment a speaker template can be compressed to about one-third of the original length, greatly saving the storage space required by the system. Furthermore, since the average is used to replace the continuous feature vectors close to each other (a plurality of adjacent feature vectors with the same code) instead of using a simple down sampling, the system performance can also be improved.

It should be noted that although in this preferred embodiment MFCC (Mel Frequency Cepstrum Coefficient) is used to express the acoustic features of an utterance, the invention has no special limitation on this, and any other known or future methods may be used to express the acoustic features of an utterance, such as LPCC (Linear Predictive Cepstrum Coefficient) or various other coefficients obtained from energy, primary sound frequency or wavelet analysis, as long as they can express the personal utterance features of a speaker.

Besides, according to a variant of this embodiment, a representative vector is randomly selected from a plurality of adjacent feature vectors with the same code and used to replace the plurality of adjacent feature vectors with the same code, in stead of using the average of continuous feature vectors close to each other (a plurality of adjacent feature vectors with the same code) to replace the continuous feature vectors .

Alternatively, a feature vector closest to the feature vector corresponding to the code in the codebook may be selected from the plurality of adjacent feature vectors with the same code as a representative vector and used to replace the plurality of adjacent feature vectors with the same code.

Besides, alternatively, the plurality of adjacent feature vectors with the same code may be replaced with the feature vector corresponding to the code in the codebook.

Besides, alternatively, a distance between each of the plurality of adjacent feature vectors designated with the same code and the feature vector corresponding to the code in the codebook may be calculated; and then the average vector is calculated for the plurality of adjacent feature vectors with the same code excluding the one or more feature vectors having the largest distances; and the plurality of adjacent feature vectors with the same code is replaced with the calculated average vector.

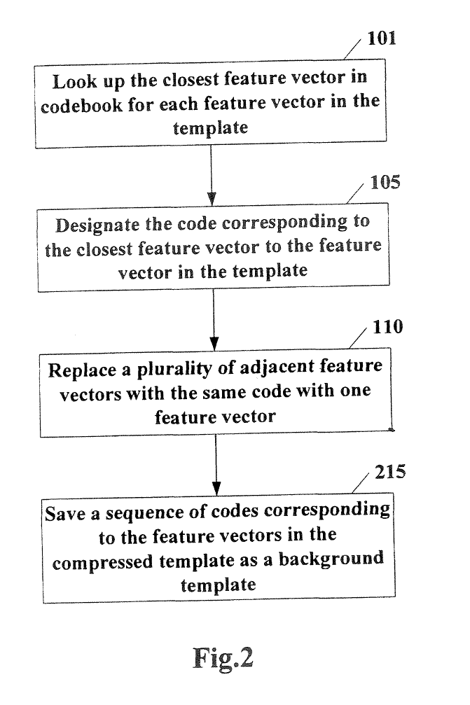

FIG. 2 is a flowchart showing a method for compressing a speaker template according to another embodiment of the present invention. Next, with reference to FIG. 2, a description of this embodiment will be given, with the description of the parts similar to those in the above-mentioned embodiments being omitted as appropriate.

As shown in FIG. 2, Steps 101 to 110 of the method for compressing a speaker template of this embodiment are the same as those of the embodiment shown in FIG. 1, and they will not be repeated here.

After one feature vector is used to replace a plurality of adjacent feature vectors with the same code in the speaker template (Step 110), in Step 215, the sequence of codes corresponding to the feature vectors in the compressed speaker template is stored as a background template. Specifically, after compression of the speaker template in the previous Steps 101 to 110, the template contains fewer feature vectors than those of the original template. These feature vectors constitute a sequence of feature vectors and each feature vector in the sequence is designated with a code, thus the sequence of feature vectors corresponds to a sequence of codes. In this step, it is this sequence of codes that is saved as a background template.

In this way, the method for compressing a speaker template of this embodiment can not only generate a compressed speaker template, but also generate a background template. The background template will be used by the method and apparatus for verification of speaker authentication described later to normalize a matching score, so as to improve the verification accuracy.

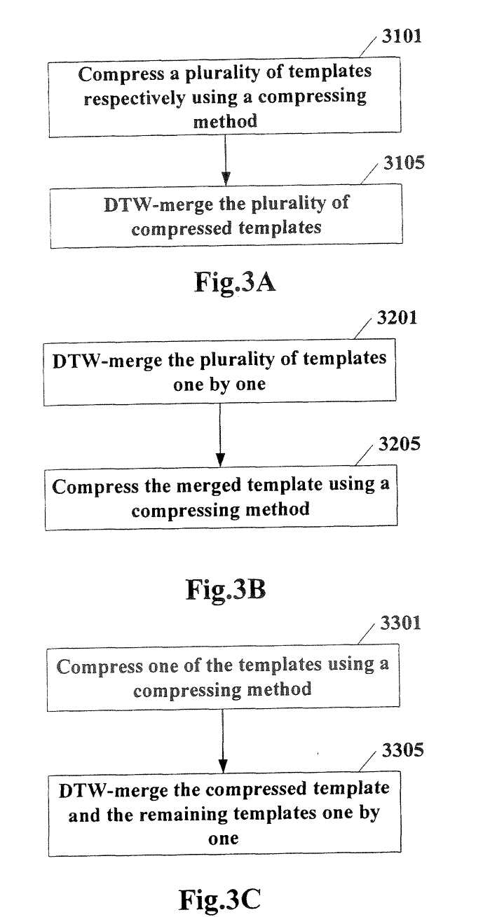

Under the same inventive concept, FIG. 3A-3C are flowcharts showing methods for merging a plurality of speaker templates according to three embodiments of the present invention. Next, with reference to FIG. 3A-3C, a description of these embodiments will be given, with the description of the parts similar to those in the above-mentioned embodiments being omitted as appropriate.

As shown in FIG. 3A, first in Step 3101, the method for merging a plurality of speaker templates of this embodiment compresses the plurality of speaker templates to be merged respectively by using the method for compressing a speaker template of an embodiment described above.

Then in Step 3105, DTW-merging is conducted on the plurality of compressed speaker templates one by one. Specifically, an existing method for template merging may be used, for instance, as described in the above referenced article “Cross-words reference template for DTW-based speech recognition systems” (IEEE TENCON 2003, pp. 1576-1579) by W. H. Abdulla, D. Chow and G. Sin, wherein first a template is selected as an initial template, to which a second template is then time aligned by using the method of DTW. The averages of the corresponding feature vectors in these two templates are used to generate a new template, to which a third template is then time aligned and so on. This process is repeated until all the training utterances have been combined into a separate template. In the present application, this method for template merging is called as DTW-merging.

From the above description it can be seen that if the method for merging a plurality of speaker templates of this embodiment is adopted, since each speaker template has been compressed by using the method for compressing a speaker template described above before the DTW-merging, the length of the merged speaker template is greatly reduced, so that the storage space can be saved.

As shown in FIG. 3B, first in Step 3201, the method for merging a plurality of speaker templates of this embodiment DTW-merges the plurality of speaker templates one by one to form a separate template.

Then, in Step 3205, the DTW-merged separate template is compressed by using the method for compressing a speaker template of an embodiment described above.

If the method for merging a plurality of speaker templates of this embodiment is adopted, since the method for compressing a speaker template of a previous embodiment is used to compress the speaker template after the DTW-merging, the length of the merged speaker template is greatly reduced, so that the storage space can be saved.

As shown in FIG. 3C, first in Step 3301, the method for merging a plurality of speaker templates of this embodiment compresses one of these speaker templates to be merged using the method for compressing a speaker template of an embodiment described above.

Then, in Step 3305, the, compressed speaker template is DTW-merged with the remaining ones of these speaker templates one by one. It should be pointed out that, during the DTW-merging of Step 3305, it is required to take the compressed speaker template as a base template. This is because the number of feature vectors in the DTW-merged template corresponds to the number of feature vectors in the base template, that is, after the DTW-alignment of the two templates, each of the feature vector in the base template is used as a unit for averaging and merging. As such, if taking an uncompressed template as the base template to conduct the DTW-merging, the effect of reducing the number of feature vectors will not be obtained finally.

From the above description it can be seen that if the method for merging a plurality of speaker templates of this embodiment is adopted, the length of the speaker template is also reduced, so that the storage space can be saved.

Besides, in Step 3301, an above-described compressing method can also be used to compress more than one template of the plurality of speaker templates to be merged.

Under the same inventive concept, according to an embodiment of the invention, there is further provided a method for enrollment of speaker authentication. First, the method for enrollment of speaker authentication of this embodiment generates a plurality of speaker templates based on a plurality of utterances inputted by a speaker. Specifically, a prior method for generating a template may be used, for instance, through extracting acoustic features in an utterance and forming a speaker template based on the extracted acoustic features. About acoustic features and contents of a template, an description has been given before and will not be repeated here.

Next, the plurality of generated speaker templates are merged using the method for merging a plurality of speaker templates of an embodiment described above.

Thus, if the method for enrollment of speaker authentication of this embodiment is adopted, compared with prior methods, the length of the generated speaker template can be reduced, so that the storage space can be saved. Furthermore, due to not using a simple down sampling, the quality of the speaker template will not be affected too much.

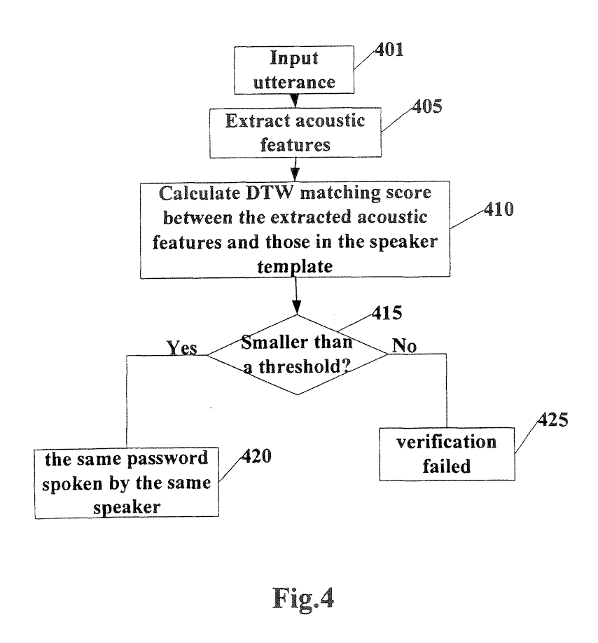

Under the same inventive concept, FIG. 4 is a flowchart showing a method for verification of speaker authentication according to an embodiment of the present invention. Next, with reference to FIG. 4, a description of this embodiment will be given, with the description of the parts similar to those in the above-mentioned embodiments being omitted as appropriate.

As shown in FIG. 4, first in Step 401, a test utterance is inputted. Then, in Step 405, acoustic features are extracted from the inputted utterance. As in above-mentioned embodiments, the present invention has no special limitation on the acoustic features, for instance, MFCC, LPCC or other various coefficients obtained from energy, primary sound frequency or wavelet analysis may be used, as long as they can express the personal utterance features of a speaker; but the method for getting the acoustic features should correspond to that used in the speaker template generated in the user's enrollment.

Next, in Step 410, the DTW matching distance between the extracted acoustic features and the acoustic features contained in the speaker template is calculated. Here, the speaker template in this embodiment is a speaker template generated using the method for compressing a speaker template of a previous embodiment.

Then, in Step 415, it is determined whether the DTW matching distance is smaller than a predetermined decision threshold. If so, the inputted utterance is determined as the same password spoken by the same speaker in Step 420 and the verification is successful; otherwise, the verification is determined as failed in Step 425.

From the above description it can be seen that, if the method for verification of speaker authentication of this embodiment is adopted, a speaker template generated by using the method for compressing a speaker template of an embodiment described above may be used to perform verification of a user's utterance. Since the data volume of the speaker template is greatly reduced, the computation amount and storage space may be greatly reduced during the verification, which is suitable to the terminal equipments with limited processing capability and storage capacity.

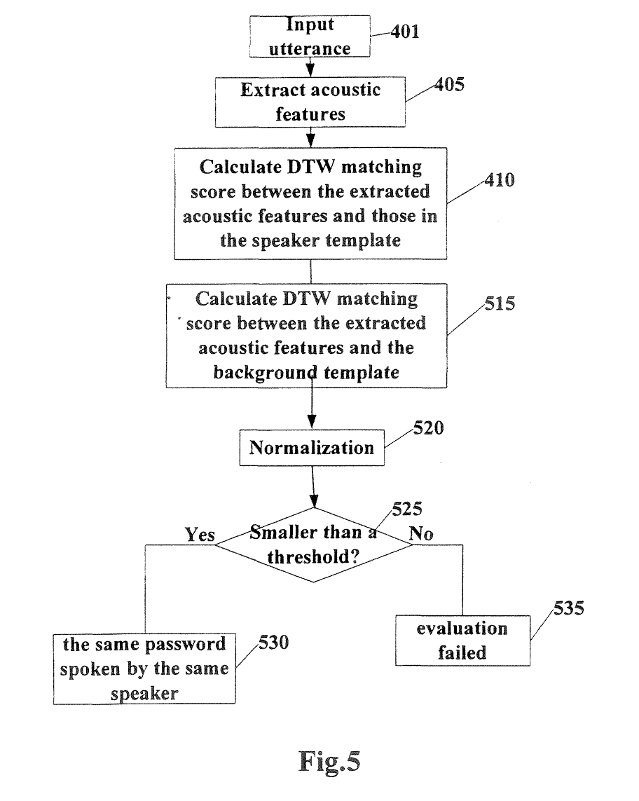

FIG. 5 is a flowchart showing a method for verification of speaker authentication according to another embodiment of the present invention. Next, with reference to FIG. 5, a description of this embodiment will be given, with the description of the parts similar to those in the above-mentioned embodiments being omitted as appropriate.

The difference between this embodiment and the embodiment shown in FIG. 4 is that this embodiment not only uses the speaker template generated by using the method for compressing a speaker template of an embodiment described above, but also uses the background template generated by using the method for compressing a speaker template of an embodiment described above to normalize the scoring.

As shown in FIG. 5, in Steps 401 to 410, this embodiment is basically the same as the embodiment shown in FIG. 4. Next, in Step 515, the DTW matching score of the acoustic features extracted from the test utterance and the background template is calculated. Specifically, as described in the previous embodiments, a background template contains a sequence of codes corresponding to the feature vectors in the compressed speaker template. In this step, the sequence of codes in the background template is converted to a sequence of feature vectors based on the feature vectors in the codebook corresponding to the codes in the sequence of codes respectively; then the DTW matching score of the feature vectors converted from the background template and the acoustic features extracted from the test utterance is calculated.

Next, in Step 520, the DTW matching score of the acoustic features of the test utterance and the background template mentioned above is used to normalize the DTW matching score of the acoustic features of the test utterance and the speaker template, that is, subtracting the DTW matching score of the acoustic features of the test utterance and the background template mentioned above from the DTW matching score of the acoustic features of the test utterance and the speaker template.

Next, in Step 525, the normalized DTW matching score is compared to a threshold to determine whether the test utterance is the enrollment password utterance spoken by the same speaker.

If the normalized DTW matching score is less than the threshold, then the test utterance is determined as the same password spoken by the same speaker in Step 530 and the verification is successful; otherwise, in Step 535, the verification is determined as failed.

From the above description it can be seen that, if the method for verification of speaker authentication of this embodiment is adopted, the speaker template generated by using a method for compressing a speaker template of an embodiment described above may be used to perform verification of a user's utterance. Since the data volume of the speaker template is greatly reduced, the computation amount and storage space may be greatly reduced during the verification, which is suitable to the terminal equipments with limited processing capability and storage capacity. Further, this embodiment also provides a method for normalizing a matching score to a system for speaker authentication based on template matching. This is equivalent to setting a template-dependent optimal threshold for each template, greatly enhancing the system performance. That is to say, even a unified threshold is used, proper determination may be made according to different speaker templates and background templates.

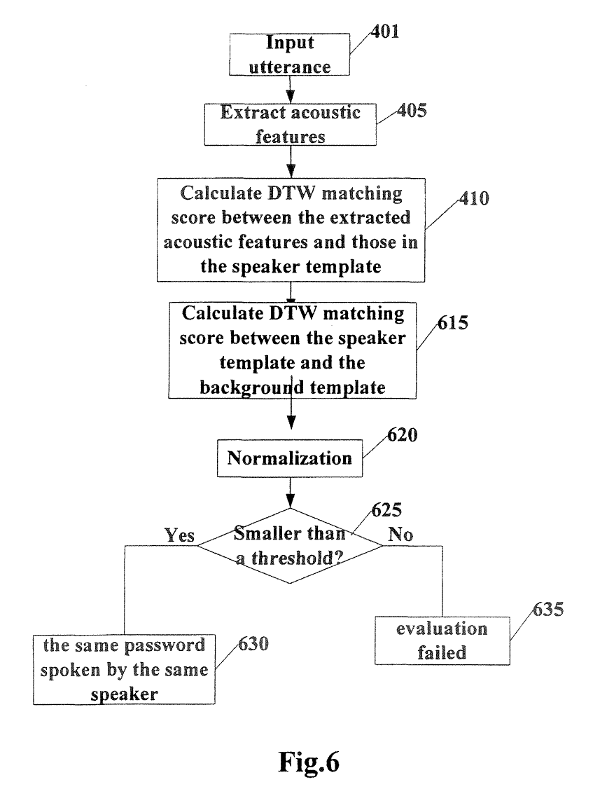

FIG. 6 is a flowchart showing a method for verification of speaker authentication according to still another embodiment of the present invention. Next, with reference to FIG. 6, a description of this embodiment will be given, with the description of the parts similar to those in the above-mentioned embodiments being omitted as appropriate.

Similar to the embodiment shown in FIG. 5, this embodiment not only uses the speaker template generated by using the method for compressing a speaker template of an embodiment described above, but also uses the background template generated by using the method for compressing a speaker template of an embodiment described above to normalize the scoring.

As shown in FIG. 6, in Steps 401 to 410, this embodiment is basically the same as the embodiments shown in FIG. 4 and FIG. 5. Next, in Step 615, the DTW matching score of the background template and the speaker template is calculated. Specifically, as described in the previous embodiments, a background template contains a sequence of codes corresponding to the feature vectors in the compressed speaker template. In this step, the sequence of codes in the background template is converted to a sequence of feature vectors based on the feature vector in the codebook corresponding to each code in the sequence of codes; then the DTW matching score of the feature vectors converted from the background template and the acoustic features in the speaker template is calculated.

Next, in Step 620, the DTW matching score of the background template and the speaker template is used to normalize the DTW matching score of the acoustic features of the test utterance and the speaker template, that is, subtracting the DTW matching score of the background template and the speaker template from the DTW matching score of the acoustic features of the test utterance and the speaker template.

Next, in Step 625, the normalized DTW matching score is compared to a threshold to determine whether the test utterance is the enrollment password utterance spoken by the same speaker.

If the normalized DTW matching score is less than the threshold, then the test utterance is determined as the same password spoken by the same speaker in Step 630 and the verification is successful; otherwise, in Step 635, the verification is determined as failed.

From the above description it can be seen that, if the method for verification of speaker authentication of this embodiment is adopted, the speaker template generated by using the method for compressing a speaker template of an embodiment described above may be used to perform verification of a user's utterance. Since the data volume of the speaker template is greatly reduced, the computation amount and storage space may be greatly reduced during the verification, which is suitable to the terminal equipments with limited processing ability and storage capacity. Further, this embodiment also provides a method for normalizing a matching score to a system for speaker authentication based on template matching. It is equivalent to setting a template-dependent optimal threshold for each template, greatly enhancing the system performance. That is to say, even a unified threshold is used, proper determination may be made according to different speaker templates and background templates.

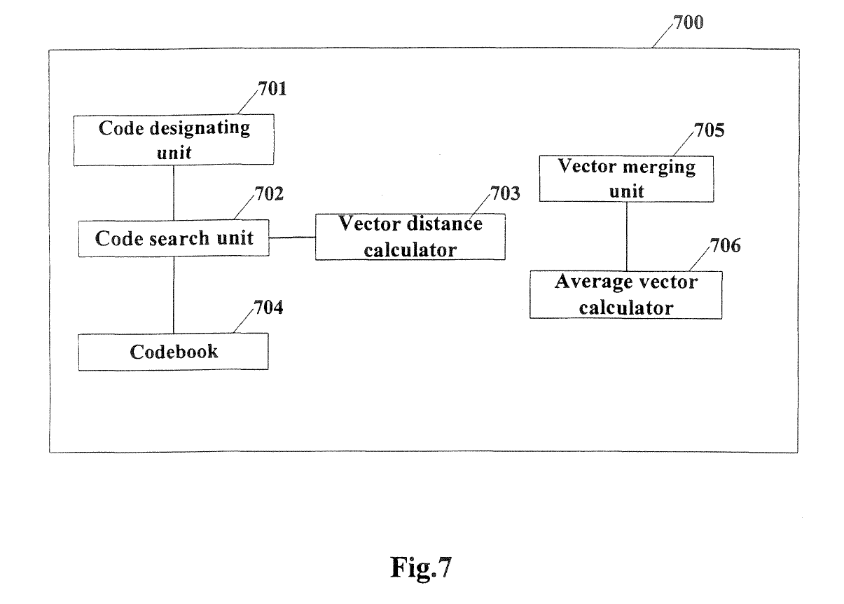

Under the same inventive concept, FIG. 7 is a block diagram showing an apparatus for compressing a speaker template according to an embodiment of the present invention. Next, with reference to FIG. 7, a description of this embodiment will be given, with the description of the parts similar to those in the above-mentioned embodiments being omitted as appropriate.

As shown in FIG. 7, the apparatus 700 for compressing a speaker template of this embodiment includes: a code designating unit 701 configured to designate a code to each of the plurality of feature vectors in the speaker template according to a codebook, a description of the codebook and the speaker template having been given above and not being repeated here; and a vector merging unit 705 configured to replace a plurality of adjacent feature vectors designated with the same code in the speaker template with one feature vector.

Furthermore, the apparatus 700 for compressing a speaker template further includes: a vector distance calculator 703 configured to calculated the distance between two vectors; and a code search unit 704 configured to search the codebook for a feature vector closest to a given feature vector and the corresponding code thereof using the vector distance calculator 703. Thus, the code designating unit 701 can use the code search unit 704 to search the codebook so as to find a closest feature vector for each feature vector in the speaker template and designate its corresponding code to the feature vector in the template.

As shown in FIG. 7, the apparatus 700 for compressing a speaker template further includes: an average vector calculator 706 configured to calculate the average vector for a plurality of feature vectors. Thus, the vector merging unit 705 can use the average vector calculator 706 to calculate the average vector of a plurality of adjacent feature vectors with the same code to replace said plurality of adjacent feature vectors with the same code.

Besides, according to a variant of this embodiment, the vector merging unit 705 can also use the average vector calculator 706 to calculate the average vector of the plurality of adjacent feature vectors designated with the same code excluding at least one feature vector having the largest distance, to replace said plurality of adjacent feature vectors designated with the same code.

Alternatively, the vector merging unit 705 can also select a representative vector randomly from the plurality of adjacent feature vectors with the same code in the speaker template, to replace said plurality of adjacent feature vectors with the same code.

Alternatively, the vector merging unit 705 can also select a feature vector closest to the feature vector corresponding to the code in the codebook from the plurality of adjacent feature vectors with the same code in the speaker template, to replace said plurality of adjacent feature vectors with the same code.

Alternatively, the vector merging unit 705 can also use the feature vector corresponding to the code in the codebook, to replace the plurality of adjacent feature vectors with the same code.

Besides, according to a variant of this embodiment, the apparatus 700 for compressing a speaker template further includes: a background template generator configured to store a sequence of codes corresponding to the feature vectors in the compressed speaker template as a background template.

The apparatus 700 for compressing a speaker template and its components in this embodiment can be constructed with specialized circuits or chips, and can also be implemented by a computer (processor) executing the corresponding programs. And the apparatus 700 for compressing a speaker template in this embodiment can operationally implement the method for compressing a speaker template of the embodiments described above.

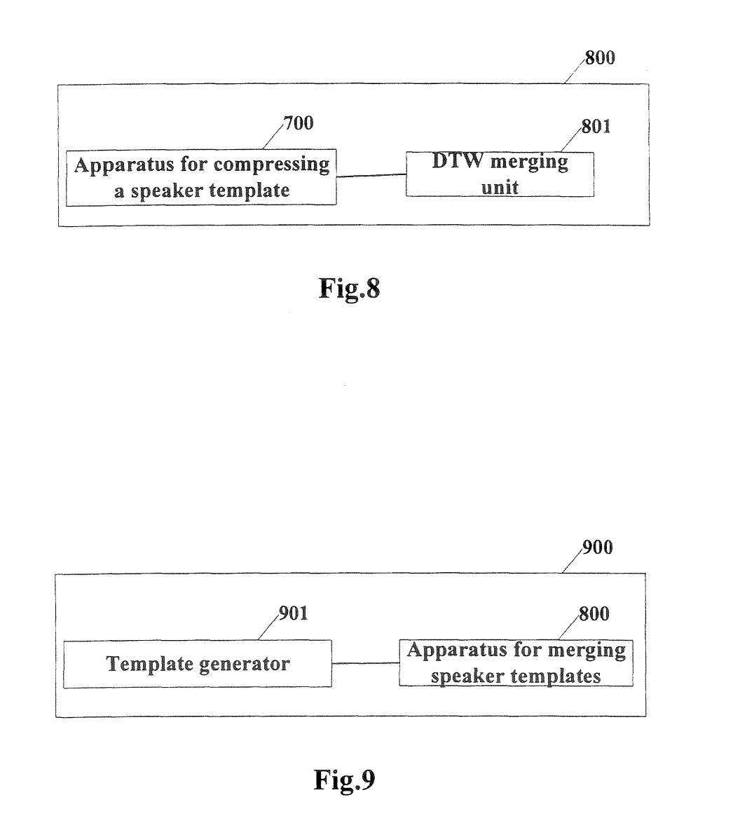

Under the same inventive concept, FIG. 8 is block diagram showing an apparatus for merging a plurality of speaker templates according to an embodiment of the present invention. Next, with reference to FIG. 8, a description of this embodiment will be given, with the description of the parts similar to those in the above-mentioned embodiments being omitted as appropriate.

As shown in FIG. 8, the apparatus 800 for merging a plurality of speaker templates of this embodiment includes: an apparatus 700 for compressing a speaker template, which may be the apparatus for compressing a speaker template described above with reference to FIG. 7; and a DTW merging unit 801 configured to DTW-merge two speaker templates, and as mentioned above, an existing DTW merging method may be used to merge two speaker templates.

The apparatus 800 for merging a plurality of speaker templates and its components in this embodiment can be constructed with specialized circuits or chips, and can also be implemented by a computer (processor) executing the corresponding programs. And the apparatus 800 for merging a plurality of speaker templates of this embodiment can operationally implement the method for merging a plurality of speaker templates of the embodiments described above with reference to FIGS. 3A-3C.

Under the same inventive concept, FIG. 9 is a block diagram showing an apparatus for enrollment of speaker authentication according to an embodiment of the present invention. Next, with reference to FIG. 9, a description of this embodiment will be given, with the description of the parts similar to those in the above-mentioned embodiments being omitted as appropriate.

As shown in FIG. 9, the apparatus 900 for enrollment of speaker authentication of this embodiment includes: a template generator 901 configured to generate a speaker template based on an utterance inputted by a speaker, with, as mentioned above, a prior method for generating a template, for instance, sampling and extracting acoustic features in an utterance and forming a speaker template based on the extracted acoustic features; and an apparatus 800 for merging a plurality of speaker templates, which may be the apparatus for merging a plurality of speaker templates described above with reference to FIG. 7, configured to merge a plurality of speaker templates generated by the template generator 901.

The apparatus 900 for enrollment of speaker authentication and its components in this embodiment can be constructed with specialized circuits or chips, and can also be implemented by a computer (processor) executing the corresponding programs. And the apparatus 900 for enrollment of speaker authentication in this embodiment can operationally implement the method for enrollment of speaker authentication of the embodiments described above.

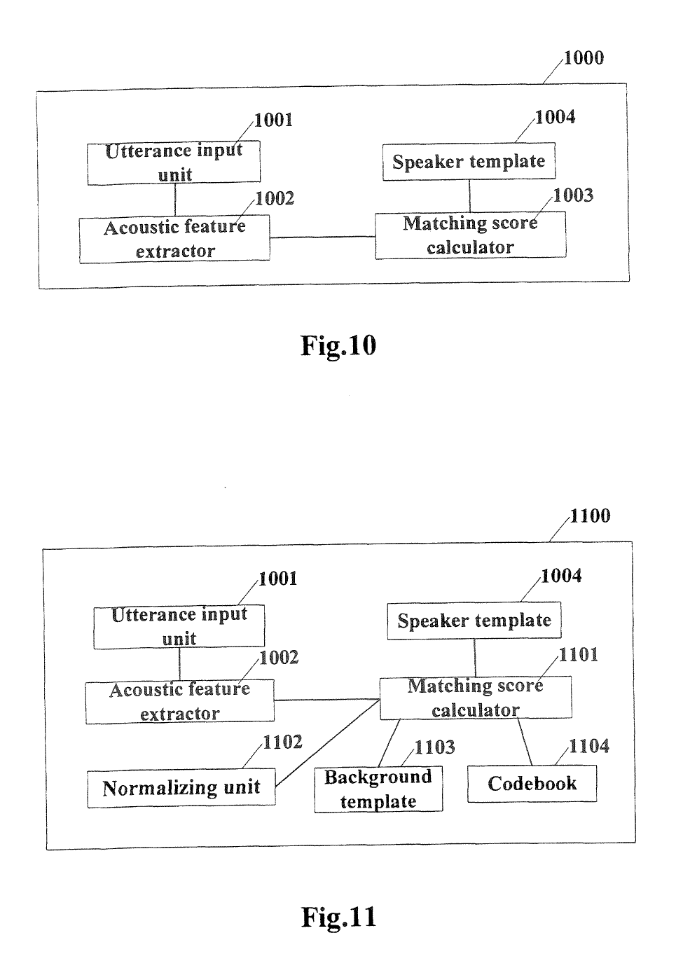

Under the same inventive concept, FIG. 10 is a block diagram showing an apparatus for verification of speaker authentication according to an embodiment of the present invention. Next, with reference to FIG. 10, a description of this embodiment will be given, with the description of the parts similar to those in the above-mentioned embodiments being omitted as appropriate.

As shown in FIG. 10, the apparatus 1000 for verification of speaker authentication of this embodiment includes: an utterance input unit 1001 configured to input an utterance; an acoustic feature extractor 1002 configured to extract acoustic features from the inputted utterance; a matching score calculator 1003 configured to calculate the DTW matching score of the acoustic features extracted by the acoustic feature extractor 1002 and a speaker template 1004, wherein the speaker template 1004 is generated by using the method for compressing a speaker template of an embodiment described above. The apparatus 1000 for verification of speaker authentication of this embodiment is configured to determine whether the inputted utterance is an enrolled password utterance spoken by the same speaker through comparing the calculated DTW matching score with a predetermined decision threshold.

The apparatus 1000 for verification of speaker authentication and its components in this embodiment can be constructed with specialized circuits or chips, and can also be implemented by a computer (processor) executing the corresponding programs. And the apparatus 1000 for verification of speaker authentication in this embodiment can operationally implement the method for verification of speaker authentication of the embodiments described above.

FIG. 11 is a block diagram showing an apparatus for verification of speaker authentication according to another embodiment of the present invention. Next, with reference to FIG. 11, a description of this embodiment will be given, with the description of the parts similar to those in the above-mentioned embodiments being omitted as appropriate.

As shown in FIG. 11, similar to the previous embodiment, the apparatus 1100 for verification of speaker authentication of this embodiment includes an utterance input unit 1101 and an acoustic feature extractor 1102. The difference between this embodiment and the previous embodiment is that this embodiment not only use the method for compressing a speaker template of an embodiment described above to generate the speaker template 1004, but also use the method for compressing a speaker template of an embodiment described above to generate a background template 1103.

The apparatus 1100 for verification of speaker authentication of this embodiment further includes: a matching score calculator 1101 configured to calculate the DTW matching score of the acoustic features extracted by the acoustic feature extractor 1002 and the speaker template 1004 and to calculate the DTW matching score of the acoustic features extracted by the acoustic feature extractor 1002 and the background template 1103; and a normalizing unit 1102 configured to normalize the DTW matching score of the extracted acoustic features and the speaker template with the DTW matching score of the extracted acoustic features and the background template. Thus the apparatus 1100 for verification of speaker authentication of this embodiment may compare the normalized DTW matching score with a threshold to determine whether the inputted utterance is an enrolled password utterance spoken by the same speaker.

Alternatively, according to a variant of this embodiment, the matching score calculator 1101 can also be configured to calculate the DTW matching score of the acoustic features extracted by the acoustic feature extractor 1002 and the speaker template 1004, and to calculate the DTW matching score of the speaker template 1004 and the background template 1103. The normalizing unit 1102 is configured to normalize the DTW matching score of the extracted acoustic features and the speaker template 1004 with the DTW matching score of the speaker template 1004 and the background template 1103. Thus the apparatus 1100 for verification of speaker authentication of this variant may also compare the normalized DTW matching score with a threshold to determine whether the inputted utterance is an enrolled password utterance spoken by the same speaker.

The apparatus 1100 for verification of speaker authentication and its components in this embodiment can be constructed with specialized circuits or chips, and can also be implemented by a computer (processor) executing the corresponding programs. And the apparatus 1100 for verification of speaker authentication in this embodiment can operationally implement the method for verification of speaker authentication of the embodiments described above.

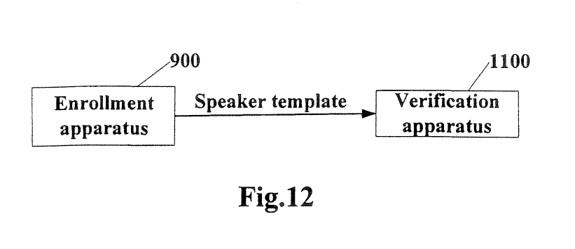

Under the same inventive concept, FIG. 12 is a block diagram showing a system for speaker authentication according to an embodiment of the present invention. Next, with reference to FIG. 12, a description of this embodiment will be given, with the description of the parts similar to those in the above-mentioned embodiments being omitted as appropriate.

As shown in FIG. 12, the system for speaker authentication of this embodiment includes: an enrollment apparatus 900, which can be the apparatus for enrollment of speaker authentication described in an above-mentioned embodiment; and an verification apparatus 1100, which can be the apparatus for verification authentication described in an above-mentioned embodiment. The speaker template generated by the enrollment apparatus 900 is transferred to the verification apparatus 1100 by any communication means, such as a network, an internal channel, a disk or other recording media, etc.

Thus, if the system for speaker authentication of this embodiment is adopted, since the data volume of the speaker template is greatly reduced, the computation amount and storage space may be greatly reduced during the verification. Furthermore, if a background template is used in the verification apparatus 1100 to perform normalization, the system performance may be further improved.

Though a method and apparatus for compressing a speaker template, a method and apparatus for merging a plurality of speaker templates, a method and apparatus for enrollment of speaker authentication, a method and apparatus for verification of speaker authentication and a system for speaker authentication have been described in details with some exemplary embodiments, these embodiments are not exhaustive. Those skilled in the art may make various variations and modifications within the spirit and scope of the present invention. Therefore, the present invention is not limited to these embodiments; rather, the scope of the present invention is only defined by the appended claims.

1. A method for compressing a speaker template that includes a plurality of feature vectors, comprising:
designating a code to each of said plurality of feature vectors in said speaker template according to a codebook that includes a plurality of codes and their corresponding feature codes; and
replacing a plurality of adjacent feature vectors designated with the same code in the speaker template with a feature vector.

2. The method for compressing a speaker template according to claim 1, wherein said step of designating a code to each of said plurality of feature vectors in said speaker template comprises:
searching the codebook for a feature vector closest to said feature vector in the speaker template; and
designating a code corresponding to the closest feature vector in the codebook to said feature vector in the speaker template.

3. The method for compressing a speaker template according to claim 1 or 2, wherein said step of replacing a plurality of adjacent feature vectors designated with the same code in the speaker template with a feature vector comprises:
calculating an average vector for said plurality of adjacent feature vectors designated with the same code in the speaker template; and
replacing said plurality of adjacent feature vectors designated with the same code in the speaker template with said average vector.

4. The method for compressing a speaker template according to claim 1 or 2, wherein said step of replacing a plurality of adjacent feature vectors designated with the same code in the speaker template with a feature vector comprises:
select a representative vector randomly from said plurality of adjacent feature vectors designated with the same code in the speaker template; and
replacing said plurality of adjacent feature vectors designated with the same code in the speaker template with said representative vector.

5. The method for compressing a speaker template according to claim 1 or 2, wherein said step of replacing a plurality of adjacent feature vectors designated with the same code in the speaker template with a feature vector comprises:
select a feature vector closest to the feature vector corresponding to said code in the codebook from said plurality of adjacent feature vectors designated with the same code in the speaker template, as a representative vector; and
replacing said plurality of adjacent feature vectors designated with the same code in the speaker template with said representative vector.

6. The method for compressing a speaker template according to claim 1 or 2, wherein said step of replacing a plurality of adjacent feature vectors designated with the same code in the speaker template with a feature vector comprises:
replacing said plurality of adjacent feature vectors designated with the same code in the speaker template with the feature vector corresponding to said code in the codebook.

7. The method for compressing a speaker template according to claim 1 or 2, wherein said step of replacing a plurality of adjacent feature vectors designated with the same code in the speaker template with a feature vector comprises:
calculating a distance between each of said plurality of adjacent feature vectors designated with the same code in the speaker template and the feature vector corresponding to said code in the codebook;
calculating an average vector for said plurality of adjacent feature vectors designated with the same code in the speaker template except at least one feature vector having the largest distance calculated; and
replacing said plurality of adjacent feature vectors designated with the same code in the speaker template with said average vector.

8. The method for compressing a speaker template according to any one of the preceding claims, further comprising:
storing a sequence of codes corresponding to the feature vectors in the compressed speaker template as a background template.

9. A method for merging a plurality of speaker templates, comprising:
compressing said plurality of speaker templates respectively using the method for compressing a speaker template according to any one of claims 1-8; and
DTW-merging said plurality of compressed speaker templates.

10. A method for merging a plurality of speaker templates, comprising:
DTW-merging said plurality of speaker templates to form a single template; and
compressing said single template using the method for compressing a speaker template according to any one of claims 1-8; and

11. A method for merging a plurality of speaker templates, comprising:
compressing at least one of said plurality of speaker templates using the method for compressing a speaker template according to any one of claims 1-8; and
DTW-merging said at least one compressed speaker template with remaining ones of said plurality of speaker templates.

12. A method for enrollment of speaker authentication, comprising:
generating a plurality of speaker templates based on a plurality of utterances inputted by a speaker; and
merging said plurality of generated speaker templates using the method for merging a plurality of speaker templates according to any one of claims 9-11.

13. A method for verification of speaker authentication, comprising:
inputting an utterance;
determining whether the inputted utterance is an enrolled password utterance spoken by the same speaker according to a speaker template that is generated by using the method for compressing a speaker template according to any one of claims 1-8.

14. The method for verification of speaker authentication according to claim 13, wherein said step of determining whether the inputted utterance is an enrolled password utterance spoken by the same speaker comprises:
extracting acoustic features from said inputted utterance;
calculating DTW matching score of said extracted acoustic features and said speaker template; and
comparing the calculated DTW matching score with a threshold to determine whether the inputted utterance is an enrolled password utterance spoken by the same speaker.

15. A method for verification of speaker authentication, comprising:
inputting an utterance;
determining whether the inputted utterance is an enrolled password utterance spoken by the same speaker according to a speaker template and a background template that are generated by using the method for compressing a speaker template according to claim 8.

16. The method for verification of speaker authentication according to claim 15, wherein said step of determining whether the inputted utterance is an enrolled password utterance spoken by the same speaker comprises:
extracting acoustic features from said inputted utterance;
calculating DTW matching score of said extracted acoustic features and said speaker template;
calculating DTW matching score of said extracted acoustic features and said background template;
normalizing said DTW matching score of said extracted acoustic features and said speaker template with said DTW matching score of said extracted acoustic features and said background template; and
comparing the normalized DTW matching score with a threshold to determine whether the inputted utterance is an enrolled password utterance spoken by the same speaker.

17. The method for verification of speaker authentication according to claim 15, wherein said step of determining whether the inputted utterance is an enrolled password utterance spoken by the same speaker comprises:
extracting acoustic features from said inputted utterance;
calculating DTW matching score of said extracted acoustic features and said speaker template;
calculating DTW matching score of said speaker template and said background template;
normalizing said DTW matching score of said extracted acoustic features and said speaker template with said DTW matching score of said speaker template and said background template; and
comparing the normalized DTW matching score with a threshold to determine whether the inputted utterance is an enrolled password utterance spoken by the same speaker.

18. An apparatus for compressing a speaker template that includes a plurality of feature vectors, comprising:
a code designating unit configured to designate a code to each of said plurality of feature vectors in said speaker template according to a codebook that includes a plurality of codes and their corresponding feature codes; and
a vector merging unit configured to replace a plurality of adjacent feature vectors designated with the same code in the speaker template with a feature vector.

19. The apparatus for compressing a speaker template according to claim 18, further comprising:
a vector distance calculator configured to calculated a distance between two vectors; and
a code search unit configured to search the codebook a feature vector closest a given feature vector and a corresponding code thereof using said vector distance calculator.

20. The apparatus for compressing a speaker template according to claim 18 or 19, further comprising:
an average vector calculator configured to calculate an average vector for a plurality of feature vectors.

21. The apparatus for compressing a speaker template according to claim 20, wherein said vector merging unit is configured to replace said plurality of adjacent feature vectors designated with the same code in the speaker template with an average vector of said plurality of adjacent feature vectors calculated by said average vector calculator.

22. The apparatus for compressing a speaker template according to claim 20, wherein said vector merging unit is configured to replace said plurality of adjacent feature vectors designated with the same code in the speaker template with an average vector of said plurality of adjacent feature vectors except at least one feature vector having the largest distance with the feature vector corresponding to said code in the codebook.

23. The apparatus for compressing a speaker template according to claim 18 or 19, wherein said vector merging unit is configured to select a representative vector randomly from said plurality of adjacent feature vectors designated with the same code in the speaker template, to replace said plurality of adjacent feature vectors designated with the same code in the speaker template.

24. The apparatus for compressing a speaker template according to claim 18 or 19, wherein said vector merging unit is configured to select a feature vector closest to the feature vector corresponding to said code in the codebook from said plurality of adjacent feature vectors designated with the same code in the speaker template, as a representative vector, to replace said plurality of adjacent feature vectors designated with the same code in the speaker template.

25. The apparatus for compressing a speaker template according to claim 18 or 19, wherein said vector merging unit is configured to replace said plurality of adjacent feature vectors designated with the same code in the speaker template with the feature vector corresponding to said code in the codebook.

26. The apparatus for compressing a speaker template according to any one of claims 18-25, further comprising:
a background template generator configured to store a sequence of codes corresponding to the feature vectors in the compressed speaker template as a background template.

27. An apparatus for merging a plurality of speaker templates, comprising:
the apparatus for compressing a speaker template according to any one of claims 18-26; and
a DTW merging unit configured to DTW-merge speaker templates.

28. An apparatus for enrollment of speaker authentication, comprising:
a template generator configured to generate a speaker templates based on an utterances inputted by a speaker; and
the apparatus for merging a plurality of speaker templates according to claim 27, configured to merge a plurality of speaker templates generated by said template generator.

29. An apparatus for verification of speaker authentication, comprising:
an utterance input unit configured to input an utterance;
an acoustic feature extractor configured to extract acoustic features from said inputted utterance;
a matching score calculator configured to calculate DTW matching score of said extracted acoustic features and a speaker template that is generated by using the method for compressing a speaker template according to any one of claims 1-8;
wherein said apparatus is configured to determine whether the inputted utterance is an enrolled password utterance spoken by the same speaker through comparing the calculated DTW matching score with a threshold.

30. An apparatus for verification of speaker authentication, comprising:
an utterance input unit configured to input an utterance;
an acoustic feature extractor configured to extract acoustic features from said inputted utterance;
a matching score calculator configured to calculate DTW matching score of said extracted acoustic features and a speaker template and to calculate DTW matching score of said extracted acoustic features and a background template, wherein said speaker template and said background template are generated by using the method for compressing a speaker template according to claim 8; and
a normalizing unit configured to normalize said DTW matching score of said extracted acoustic features and said speaker template with said DTW matching score of said extracted acoustic features and said background template;
wherein said apparatus is configured to compare the normalized DTW matching score with a threshold to determine whether the inputted utterance is an enrolled password utterance spoken by the same speaker.

31. An apparatus for verification of speaker authentication, comprising:
an utterance input unit configured to input an utterance;
an acoustic feature extractor configured to extract acoustic features from said inputted utterance;
a matching score calculator configured to calculate DTW matching score of said extracted acoustic features and a speaker template and to calculate DTW matching score of said speaker template and a background template, wherein said speaker template and said background template are generated by using the method for compressing a speaker template according to claim 8; and
a normalizing unit configured to normalize said DTW matching score of said extracted acoustic features and said speaker template with said DTW matching score of said speaker template and said background template;
wherein said apparatus is configured to compare the normalized DTW matching score with a threshold to determine whether the inputted utterance is an enrolled password utterance spoken by the same speaker.

32. A system for speaker authentication, comprising:
the apparatus for enrollment of speaker authentication according to claim 28; and
the apparatus for verification of speaker authentication according to any one of claims 29-31.
